(19) United States
(12) Patent Application Publication
(10) Pub. No.: US 2008/0005733 A1
(43) Pub. Date: Jan. 3, 2008

(54) Method and apparatus for updating firmware and software

(76) Inventors: Balaji Ramachandran, San Diego, CA (US); Naga Shirisha Allagadda, Victoria (AU); Anusha Gururajan, Victoria (AU)

Correspondence Address: DONN K. HARMS;PATENT & TRADEMARK LAW CENTER, SUITE 100, 12702 VIA CORTINA, DEL MAR, CA, 92014, US

(21) Appl. No.: 11/478,762

(22) Filed: Jun. 29, 2006

(51) Int. Cl. G06F 9/44

(52) U.S. Cl. 717/168

(57) ABSTRACT

A computer implemented method for updating one or a combination of the system software, operating systems, device configuration, application software and firmware of electronic devices via geographically located local communication points likely to be proximate to the electronic device being updated. The communication points are connected to local servers which communicate stored update packages to the electronic device which are pre-provided by the device manufacturers, or customize update packages to the device subsequent to a query response as to the state of software, firmware, and configuration of the device to be updated.

### FIELD OF THE INVENTION

The disclosed device relates to the field of electronic devices which employ computer software to manage their operation and interface with one or a plurality of users. More particularly it relates to a method for updating the system software, operating systems, device configuration, application software and particularly the firmware of such devices which manages the overall operation of the device and its interface with other devices and computer systems and components.

### BACKGROUND OF THE INVENTION

In software driven and managed electronic devices, software may run the device itself, or on the device as an application, or as firmware which is software that is embedded in a hardware device. It is often provided on flash ROMs or as a binary image file which is stored on the device when sold, or that can be uploaded onto existing hardware by a user. The term “firmware” was originally coined to indicate that computer code was providing a functional replacement for hardware on low cost microprocessors. Such firmware was originally not undatable but since its introduction firmware for many devices can now be updated without the need for additional hardware.

In addition to firmware updates, the device and method herein can also be employed for software updates where a plurality of different types of software or components exist on the same machine or electronic device, along with the firmware on the device itself, and, on components such as video cards, modems and network and wireless modules and the like. A good example of such would be cellular phones which employ firmware and may also run software such as, for example, Windows CE, as an operating system for the various operational software programs and functions of the phone that are user-operated. The system can be employed to not only update the firmware on such a phone, but also the operating system software, and other software that the user may have loaded to run upon the phone. Since the components of such a phone and the phone itself have firmware which must interface with other components, and the operating system also must properly interface with the components and any loaded software, there is a pressing need for a means to update the various firmware versions on the device concurrently with the operating system and any loaded software programs, in a manner that prevents conflicts between the devices, the firmware versions, and the software versions, but allows for simultaneous updates of one or all.

The same holds true for automobiles and the like, as much like a complicated cell phone or computer, automobiles have numerous onboard computers and electronic systems that are interlinked to operate the vehicle. For example, brake control units employ firmware and software to handle emergency braking, ignition control devices employ firmware and software to control engine functions, and smog control devices handle pollution control in a similar fashion. With all such components linked to the operation of the vehicle and each having one or a combination of firmware and/or operating software, updates of one component can wreak havoc on the operation of the others if such updates are not handled in a fashion to avoid conflicts. In vehicles, a malfunctioning updated system such as brakes can cause an accident and engine or ignition systems which are improperly updated can cause the vehicle to cease functioning. Consequently, just as is the case with cell phones and computers, or cameras, or cell phones, or GPS units or any other electronic device, there is a vital requirement that the various firmware versions on the devices of the vehicle which are linked and the vehicle computer itself are updated in a manner that prevents conflicts between the devices, the firmware versions, and the software versions, on respective devices so as to avoid catastrophic consequences of an accident or malfunction of the vehicle running systems.

In practical terms, firmware updates improve the performance and reliability and indeed even the basic available functionality of a given electronic device. Whether the electronic device is a vehicle, a cell phone, a PDA, a camera, a microwave oven, or another electronic device, since operating systems which may be run on such devices change as does the hardware and interfaced devices, most computing devices employing firmware benefit from regular firmware updates and software updates to loaded operating systems and software. Indeed, with ever evolving processors, video cards and displays, communications hardware and standards, a device with old firmware or software can soon begin to malfunction or to lose communication and processing abilities if its firmware and software are not regularly updated.

Firmware is generally device specific. For example, firmware on a video card for a computer is loaded onto a memory device on the video card and is specific as to that video card's operation and its interface with a computer, a display, or other device to which it is engaged. The same is true about firmware on small hand-held computing devices such as a personal digital assistant (PDA) or that of a video gaming device used by children to play electronic games.

Software and operating systems such as Windows or Linux while not so much device-specific, do interface with the various components running firmware and with other software components, and consequently, updating one portion of firmware on one component without a concurrent software update, and vice versa, can cause severe operating problems with the device itself. Also, in the case of communications devices such as cell phones, PDA's, GPS devices, and the like, a change in the software or operation of the broadcasting device to which they communicate can cause the communicating device to cease functioning if its firmware or operating system or software is not updated in advance.

In practice, larger devices such as a personal computer or a video game device generally have onboard chipsets with memory in the form of flash ROM (read-only-memory) or BIOS that stores the firmware which controls the operation of the components of the device. Examples of firmware that control a device's operation can be found in the BIOS found on IBM-compatible Personal Computers, the EFI BIOS found on Itanium systems, and the Bios for Intel-based Mac OS X machines. Smaller electronic devices such as a Palm Pilot or Blackberry PDA, cell phones, and the like have similar means to store some form of firmware which operates the device and interfaces the device and its components with an operating system and software running upon it, allowing communication with other computers, phone systems, or PDA's and the like.

In the case of computers such as IBM compatible computers, frequent changes in industry standards of communication, video depiction, transmission of data, and operating system software, can cause havoc with devices and chipsets in individual computers. If the firmware of the installed base of computers and computer components such as video cards, sound cards, modems, and the like, is not kept current, a change in industry standards or operating system software can wreak havoc on the operation of older and currently operating computers.

Another example of firmware controlled devices are cellular telephones which are now used by millions of people worldwide. Such devices frequently take photographs, video, deliver text messages, and must communicate over a wireless networking system with ever-changing and upgraded standards. It is not uncommon for a cellular phone to be rendered disabled or inoperable by a change in the mode of communication provided by the carrier to which the user subscribes. For example, an upgrade in the CDMA or GSM or other wireless communication system employed by many cellular telephone service providers can cause havoc with many thousands of subscribing cellular telephones if those telephones require a concurrent upgrade in their firmware or software to continue to operate once the upgrade installed by the provider is operational. Additionally, newer cell phones also have operating systems and software that must remain updated to work with any firmware changes and to interface correctly with the various components of the phone. An error or bug in the manufacturer-supplied mobile handset firmware, operating system, or software, or, an errant change to the firmware or software initiated by a service provider, may initiate recalls of millions of handsets for upgrades of firmware or operating systems or software, all of which can be avoided by employment of the method herein.

Still further, devices such as PDA's are hostage to the ever-changing environment of computers they communicate with, broadcast or wired communication standards, cellular telephone connection and communication standards, and operating system and software upgrades by the manufacturers. A small change in any of these or other operating parameters, which is not designed to function with another component, can render the PDA's of the business gladiator useless. If rendered useless or inoperable, such devices can be very hard to fix, especially for the majority of users who are not computer or electronically adept.

While some software providers for computers and various electronic devices do provide users the ability to communicate for an update of the software which is used on the harddrive or otherwise stored, after the firmware has loaded, such firmware updates are much harder to secure and install for the user and to provide for the manufacturer. In the cases of devices other than computers such as cellular phones, digital cameras, PDA's, video games, walkie talkies, and a plethora of different electronic gear available, there is no manner in which to provide users firmware updates in a fashion that does not require the user to mail, ship, or bring the device into the manufacturer or one of their distributors for an upgrade.

Additionally, a firmware update of any individual device must take into consideration what that device is engaged to, or communicates with, before the firmware can be upgraded. Further, the operating system running on the device must also be taken into consideration as well as any software programs running on top of the operating system. Additionally, it is preferable that the device itself, its operating system, its configuration parameters for operation, and its software meet the minimum software and hardware requirements for the upgrade. If the wrong firmware upgrade is installed on the device, it can render it useless for its purpose, and in many cases it can destroy the device due to destruction of delicate electronics subsequent to or during the upgrade process.

There is as such, a pressing need for a method and system which provides for the upgrade of a wide variety of electronic devices, owned and operated by a wide variety of users, which employs software or firmware to control the overall operation of components engaged in such devices. Such a method and system should preferably be able to update the firmware on multiple components and/or software packages on multiple components or devices taking into consideration the operational characteristics of all.

In the cases of automobiles, PDA's, digital cameras, GPS devices, VCR's, DVR's, and other devices relying on delicate electronics to control their operation, there is no manner currently provided to allow manufacturers to automatically update the firmware on the device and/or the operating system and/or the software, concurrently or singularly prior to the occurrence of a problem caused by system upgrades or discovered operational flaws of the earlier firmware. Consequently, millions of motorists drive around with antiquated operating systems running their vehicles because they forget or avoid visiting a car dealer for a required system upgrade. Millions of other users of cameras, cell phones, radios, and other electronic devices employing firmware to control their operation and operating systems and other software running on the devices suffer similar problems from lack of easy upgrades.

In this respect, before explaining at least one embodiment of the invention in detail it is to be understood that the invention is not limited in its application to the details of construction and to the arrangement of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other methods and systems for carrying out the several purposes of the present invention. It is important, therefore, that the claims be regarded as including such equivalent construction insofar as they do not depart from the spirit and scope of the present invention.

An object of this invention is the provision of a method for one or a combination of firmware, software, and operating system updates which can be initiated by the manufacturer of such devices, or a service provider for such devices, without the need or requirement for the owner or user to transport the device to the manufacturer or their agent.

Another object of this invention is the provision of such a system which can provide firmware, software, and operating system upgrades via a network or wirelessly at a plurality of communication contacts or venues where such devices come into contact.

An additional object of this invention, is the provision of such a upgrading system that will inventory the needs and operational requirements of the device being upgraded prior to installation of the firmware update or operating system or software update, and thereby update the device with correct versions of all onboard firmware or software to insure continued operation.

A further object of this invention is the provision of a system to upgrade firmware, software, and operating systems on electronic devices which customizes each upgrade by interrogating the device as to all its components, operating systems, software, and communications requirements, and thereafter generating a customized firmware and/or software update individual to the needs of that device.

Yet a further object of this invention is the provision of a system to which manufacturers or service providers subscribe, wherein an upgrade checking code will be included in the initial firmware of the device sold by the manufacturer. The device will be subsequently upgraded automatically through communication therewith authorized and initiated by the upgrade code in the original firmware by wired or wireless communication on a regular basis.

Yet another object of this invention is the provision of a method for upgrading firmware and/or software and operating systems that will allow all a plurality of components linked for function on one electronic device to be individually upgraded.

These together with other objects and advantages, which will become subsequently apparent, reside in the details of the construction and operation as more fully hereinafter described and claimed, reference being had to the accompanying drawings forming a part thereof, wherein like numerals refer to like parts throughout.

### SUMMARY OF THE INVENTION

The above problems and others are overcome by the herein disclosed system for automatic updating of manufacturers' electronic devices which employ firmware to manage functions of the device. The method herein described and disclosed provided by the disclosed system provides a means to remedy the aforementioned problems. In one preferred embodiment, the method of updating provides a subscription or other means for the manufacturer or service provider to initiate a third party to update firmware or operating systems or software on one or a plurality of the manufacturer's products remotely and thereby alleviate the need to return the products to a central location for update.

In the simplest form, the system will employ code to be included in the original firmware or software stored on the device, be it a phone, a camera, a computer, a PDA, an automobile or any electronic device. The code included will cause the device to initiate communication with a local server on future dates, at random or set times, identify itself with a means for identification such as a serial number or code, and report the version of firmware and/or operating system and software, currently installed on the device. Optionally reported, depending on the device, will be installed hardware engaged with the device and communications systems and their respective requirements. Alternatively, a server may contact an electronic device to be upgraded and initiate communication therebetween in the aforementioned fashion.

The local server receiving the identification code will look up the manufacturer and/or service provider specifications of the device inquiring, from the remote location. The server will employ software to determine the newest firmware and/or software operating system upgrades the subscribing manufacturer has provided for the user device, thereafter reporting and transmitting the appropriate firmware or software or operating system upgrades over the network back to the user device. The inquiring device will thereafter update the firmware and/or software and/or operating system at an appropriate time in a fashion to keep the device operating optimally. Subsequent information to be reported to the server on subsequent occasions will contain the upgraded information.

As long as the manufacturer has authorized service by the provider to update their firmware or onboard operating systems or software per their subscription, devices manufactured by that manufacturer will be updated when they communicate with the server or it communicates with the respective device. Contact with the server can be initiated daily if the device has continuous network access or initiated any time the device or server determines there is communication over a network capable of communicating between the device and the local server.

The updates in a particularly preferred mode can be customized to the device, contacting the server based on the version of firmware already installed, the differences in the newest version, and the components and/or communication requirements, along with any operating system or other software onboard which is reported by the device inquiring of the server. An onboard software program on the server will then compare the differences between the old and new firmware and the software and operating system and hardware requirements of the device based on connected components and communications and manufacturer recommendations, and will generate program updates in the form of new firmware and/or software and/or operating system updates for that device in real time. This can be done using a library of potential updates or portions of a custom update that can be employed based on the operating system, configuration parameters, hardware and other differences noted above and custom forming the new Diff File in real time. The Diff File contains the differences between two given versions of firmware, software or programs or configuration of the device or its software for individual operation or hardware on the device to be updated.

Or, manufacturers can predetermine the proper changes to the software of firmware based on the above, and any conflicts, and can provide different versions to be used singularly or in combination for a diff file for products already manufactured with known components, software, and firmware, and can place them on the server for the update. This will avoid program updates of firmware or software or operating systems that might disable the device, and with sufficient information reported by the device as to connected components, operating systems, and communications requirements, can provide customized program updates specific to that device that will load in a shorter time and enhance the device specific to its personal requirements.

In another particularly preferred embodiment of the method herein, a device with multiple electronic components each having individual firmware and/or software or operating systems, would be updated for program information. Programs for firmware, operating systems, software for computers, for instance, on automobiles would be especially improved by this mode of the system herein since they conventionally contain a number of individual components that must communicate with each other for the vehicle to function. Each of those components being controlled by software programs, component firmware, and/or software or operating systems communicating therebetween, a mistake on updating the software or firmware of one component, can render the device non-operational. By employing the system herein, the manufacturer, in this case the car manufacturer or computer manufacturer, would subscribe with a provider to update to software and/or firmware of one or a plurality of components of the car or computer at once. The update would take into consideration the effect on the other components's software and firmware and the operation of the system as a whole, and then a customized package would be communicated to impart the update. This can be done with simple individual component updates or in and especially preferred mode, updating multiple software and firmware on multiple components with special attention being paid to the interrelated components and their respective firmware and/or software and/or operating system. By updating multiple devices or components, the product being updated can minimize the number of such updates and maximize the effect of each contact with a local server.

During a scheduled or random contact initiated by the device being updated or by the local server, one or preferably a plurality of components and devices onboard and their individual respective software, operating system, and firmware programming, would be reported to the server. Employing onboard software adapted to the purpose on the server, the individual programing of firmware, and/or software, and/or operating systems, and their respective versions, would be compared with any individual updates provided by the manufacturer. Optionally, the updates would also be examined for conflicts with each other based on the reported components and programming from the device. From this reporting and comparison a package of programing updates for the firmware, software, or operating system would be sent to the car or computer via a network. Thereafter a plurality of the individual components of an automobile, a cell phone, a PDA, a camera, or any other device which can communicate with a network, and their individual respective software and/or firmware would be updated.

Communication with computers, cell phones, cars, truck, PDA's and virtually any other electronic devices needing an upgrade would be over a network which can be via a data transmission network, via wired or wireless connection, by satellite communication, or other means for network communication between the device being updated and a server. For example, with current automobiles conventionally being equipped with satellite and/or cellular telephone communication capabilities, upgrades for vehicles can occur daily to keep the vehicle in top running order and keep all the components of the vehicle communicating with each other in the best mode available based on the actual real-time configuration of the vehicle and the individual programming of the firmware, software, or operating system of interrelated components. Such an update can be initiated by the vehicle itself or by a remote local server coming into communication with the vehicle. Of course the system is not limited to vehicles and with other modern electronic components such as cameras, PDA's cell phones, and the like having network communication capabilities built-in, any means for communicating with the local server which can be initiated by the server, or the device being upgraded to achieve communication may be employed, so long as it is appropriate to the purpose at hand.

With respect to the above description then, it is to be realized that the optimum relationships for invention are to include variations in size, materials, shape, form, function and manner of operation, assembly and use are deemed readily apparent and obvious to one skilled in the art, and all equivalent relationships to those illustrated in the drawings and described in the specification are intended to be encompassed by the present invention. Therefore, the foregoing is considered as illustrative only of the principles of the invention. Further, since numerous modifications and changes will readily occur to those skilled in the art, it is not desired to limit the invention to the exact construction, mixtures, and operation shown and described, and accordingly, all suitable modifications and equivalents may be resorted to, falling within the scope of the invention.

### BRIEF DESCRIPTION OF THE DRAWING FIGURES

The accompanying drawings which are incorporated in and form a part of this specification illustrate the improved results obtained with the method herein described.

FIG. 1 is a graphic depiction of a flow chart of a preferred embodiment of the invention wherein multiple devices on an electronic device may be updated from a local server which is itself updated by a central server.

FIG. 2 depicts a high-level internal configuration of each device which is adapted for communication with a local server for updating firmware/software of one or more operating systems or one or more software or firmware applications in each device.

FIG. 3 depicts a typical client device update mechanism wherein each client device may have one or more monolithic or non monolithic operating systems and one or more applications. The local sever is capable of communicating to both monolithic and non monolithic operating systems and can update software and/or firmware of one or more applications based on monolithic and non monolithic operating systems.

FIG. 4 is a detailed view of a typical local server of the disclosed invention having multiple components to receive, update, monitor and report the activities and having specific components to communicate to the clients as well as a central server.

FIG. 5 shows a log agent which is integrated to a dashboard application which provides user-friendly reports and graphical information.

FIG. 6 depicts the download agent of the disclosed invention which receives and decompresses update files received from central server for distribution to a local server update agent or client update agent depending upon the instruction received from central server.

FIG. 7 shows a local client device which could have a thin client residing in the device or a RAM based client which is installed in RAM and destroyed once the update is performed successfully.

FIG. 8 shows the client components overview.

FIG. 9 depicts the central server which is a set of one or more servers located centrally and are used to update the local servers as well as the client devices.

FIG. 10 depicts the diff file generator.

FIG. 11 shows the typical package making procedure of the invention.

### DETAILED DESCRIPTION OF THE PREFERRED EMBODIMENTS

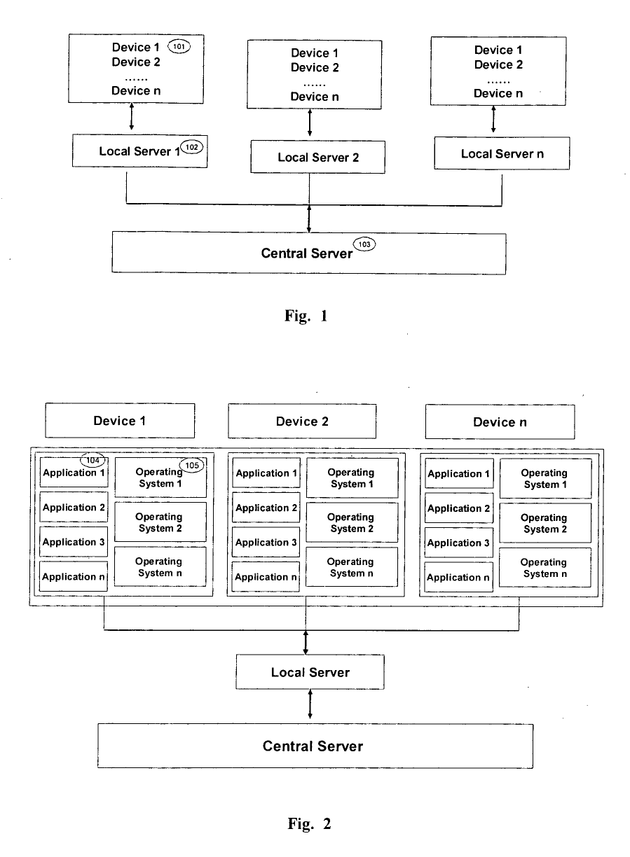

Referring now to the drawings in FIGS. 1-11, some preferred embodiments of the present invention in current preferred modes in accordance with the present invention are shown and described.

In operation, the method and system herein allows client devices operated by users or subscribers to receive updates from local servers adapted to communicate with and update a plurality of such client devices. This provides a method for manufacturer or service-provider initiated updates of firmware, software, and operating systems on multiple components on equipment to maintain them in a functioning state of operation. It also prevents potential mass malfunctions of such client devices which might occur from software or hardware or system updates by a service provider and negates the need for users of the client devices to contact the manufacturer or service provider for such software and firmware updates. Communication between such client devices and the server upgrading them can be initiated by either.

The method is initiated with a manufacturer or equipment supplier or service provider subscribing to the service operated by a third party, or which installs the service to update their client devices sold, so that the respective electronic client devices can be updated without the need for the user or owner to contact the manufacturer. This also alleviates the need to ship or bring the device to the manufacturer for updates to the firmware or software of one or a plurality of components resident on the device and the device's firmware and/or the operating system or software.

The subscriber would then determine a need for updating the client device and provide the central server with the update package file which provides a means for updating the firmware or software on the client device. The central server is adapted with software to then select appropriate local servers for this supplied update. The central server in the preferred mode compresses the update package file and converts to an appropriate format understandable by local server determined to receive it. The central server then transmits the update package file to one or a plurality of local servers over a data transmission network, in communication with the local server. Upon receipt of the update package, it is partially or totally decompressed if it is compressed and then analyzed for the proper target client devices for the update package.

Initial communication between the local server and a client device being upgraded may be initiated by either the server or the device. Depending on the determined target client devices, the local server decides an appropriate communication mechanism and algorithms and transmits the relevant update package file to the relevant devices determined to need it. Depending on the client mode (i.e., thin client or RAM based client), an initiation of the client devices to receive the update package is done and thereafter the intended client devices receive the update package file to thereupon update one or a combination of firmware, operating system, and software of one or a plurality of components of the client device. Once successful, the client device confirms to the local server the status of the update of the software or firmware of the local device. The client device can be queried for status by the local server at any point in time. If it is a RAM based client, after a successful update the update package which also included the client is destroyed.

After or during the update of the client devices, the local server then sends the confirmation message along with relevant parameters to central server 103. Of course the central server 103 can also query the local server for status at any given point in time. Also, the local server logs relevant information in the log agent, whereafter the central server receives confirmation and logs relevant information.

As shown a client device 101 located at client's site is updated using a local server 102 which as noted above has received a communicated update package adapted for updating the firmware and/or software of specific client devices 101. The firmware or software updated can be one or a combination of updates including firmware, software, or operating system software, of one or a plurality of electronic components resident on the client device 101. The local server 102 receives instructions and an appropriate update package file from the central server 103.

The central server 103 is located at a central location and communicates over a network to deliver the instructions and update package files to one or more local servers 102 positioned to communicate with the intended client devices 101. The local server 102 as noted is adapted with software and hardware to communicate the update packages to the appropriate client devices 101 as well as the package for updating the local server 102 itself, subsequent to contact with a client device 101. Central server 103, in turn, can get updated as required by the customer. The placement of many local servers 102 adapted to seamlessly communicate with remotely located client devices 101 as they come into contact with any of the local servers 102, thereby provides for easy updates of the firmware and/or software on the client devices 101 at the initiative of the manufacturer or service provider to the user of the client device 101 or the client device itself. In the case of manufacturers or service providers, such updates thereby initiated can be done so as to prevent mass outings of such client devices 101 from system and communication changes that might occur and be unknown to the user of the client device 101.

The local servers 102 would of course, be adapted with software to communicate with and query any client device 101 that might come into contact with it. For example, a local server 102 could be placed to wirelessly communicate automobiles which might slow to negotiate a toll gate on a highway or any one of a multitude of electronic devices located in the automobile, be it a cell phone, a PDA, a laptop, a GPS unit, or a wristwatch on the driver. Once it is determined that a client device 101 that needs to be updated is in communication, the client device 101 would be queried to determine the state of the firmware, software, configuration parameters, or operating systems, and optionally can be adapted to query the specific electronic equipment on the client device and its current software or firmware. If an update package has been sent to the local server 102 that has been designated for upload to the communicating client device 101, the update package would be communicated to the client device 101 from the local server 102 and one or a combination of software, firmware, or operating systems of the device 101 and/or its components would be updated.

As shown in FIG. 2 each local device 101 might have a plurality of application programs 104 and one or more operating systems 105 which may be monolithic or non-monolithic. The local server 102 would determine the state of software and/or firmware on the local device 101 and provide one or a plurality of update packages as noted above if required.

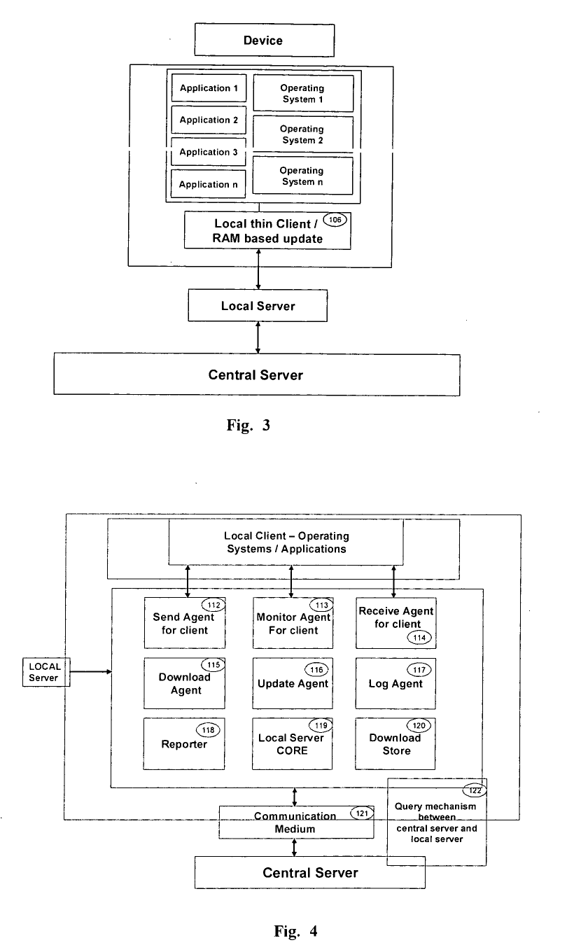

FIG. 3 depicts a local thin client 106 ram based program update within the client device 101 for updating the operating systems and applications residing in the client device 101. In some cases the client used to update the local devices 101 may not be residing permanently within the client device 101. As shown the random access memory of the local device is used as a place holder to temporarily install and operate the client which is used to update one or a combination of firmware, operating system and software applications of the client device 101. After successfully updating, the temporary client installed in the RAM will destroy itself.

As shown a send agent for client 112 is used for communicating to the end client device 101 and for receipt of the instruction from the local server 102 CORE and gets relevant update package files from the download store. The monitor agent 113 monitors the update process of the client device 101. It also interacts with send agent 112 or local server CORE 119 as relevant in case of any issues with the updates process. The key purpose of monitoring agent for client 113 is to ensure that the update happens appropriately to one or a combination of updates to the client device including the firmware, operating system, or software on the client device 101. It also helps in providing the characteristics of a target client device 101 in advance to a local server 102 for preparing the communication mode etc. for initiating the update.

The receive agent 114 provides a single point of contact for client device 101 to communicate to Local Server CORE. The send agent for client 112 and receive agent for client 113 are capable of communicating the updates to client devices 101. As already noted above, the client device 101 may either be updated using thin client 106 or using RAM based update mechanism. The send agent for client 112 and receive agent 114 of the local server 102 is adapted with communication capabilities to address these two types of target communication needs to targeted client devices 101.

Also shown is download agent 115, which is responsible for downloading the update package files and other instructions from central server 103. Download agent 115 downloads relevant update package files and then stores them on the local server 102 for communication to determined targeted client devices 101 in the under Download Store 120 area. Components of locally generated update package files to be stored on the local server and used to generate custom update package files can also be handled in this fashion to allow custom real time generation of update package files on the local server 102 based on query responses from a device. A primary purpose of download agent 115 is to receive and decompress, if necessary, the update file communicated from the central server 103, and thereafter distribute the same to either the local server update agent 116 or client update agent depending upon the instruction received from central server 103. This update agent 116, as noted, may be employed for updating the local server 101 for its own updates in one or a combination of updates to firmware, software, or operating system.

Shown in FIG. 4, log agent 117 is employed to log various activities related to local server download, updates and other functions as well as client side download and update. It has an appropriate interface with reporting tools. Reporter 118 provides a means for generating various reports from logs as well as update transactions to local server 102 as well as central server 103. The local server CORE 119 contains the firmware/OS of the local server 102 and may as noted above be updated with the update package files sent by the central server 103. The download store 120 provides a data area for electronic storage of the update package files sent by central server 103 for updating local server 102 and/or one or a combination of firmware, operating systems and software applications on the client device 101.

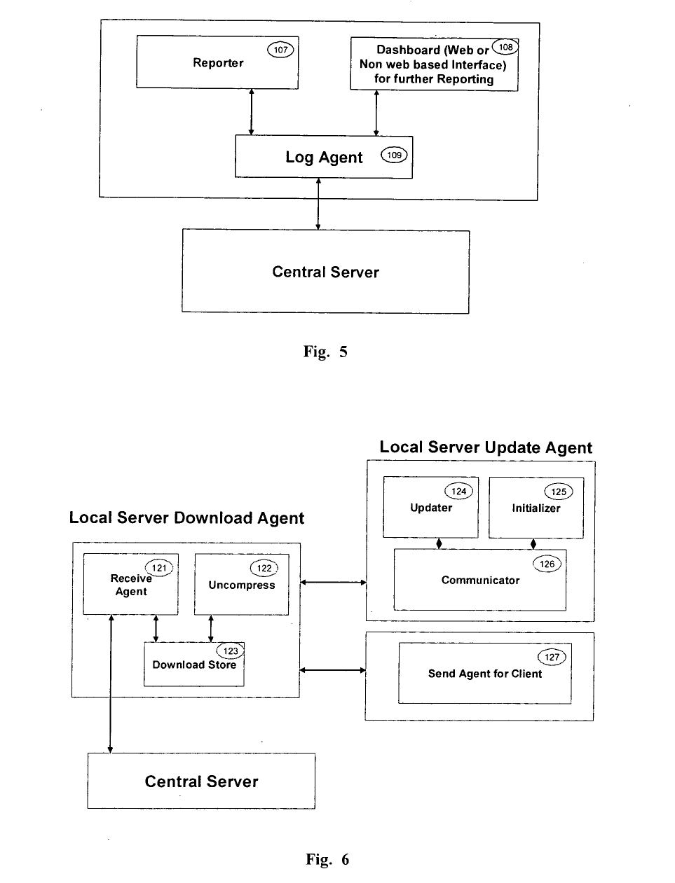

As shown in FIG. 5, reporter 107 is used for generating various reports from logs as well as update transactions to local server 102 as well as central server 103 users. Dashboard 108 is a high-level summary report with reasonable drill down capability which enables users a means to select and review the relevant information required. Log agent 109 is used to log various activities related to local server download, updates and other functions as well as client side download and update. It is adapted to interface with reporting tools.

FIG. 6 depicts the local server download agent and interrelation of receive agent 121 which is adapted with a communication medium, which is protocol agnostic, to communicate between local server 102 and central server 103. There is a specific communication medium between central server 103 and local server 102 which would be selected based on specific requirements of the need and characteristics of local server 102. There shall also be a querying mechanism between local server 102 and central server 103 for exchanging and reporting information related to update instructions, update package files, update status, log information etc. The local server download agent thus provides the mechanism to enable the users of central server 103 to query the local server 102 to monitor its status, as well as get updates and requirements for updates from client devices 101 communicating thereto through local server 102. It provides a means for the users of central server 103 to stay in communication with relevant local servers 102 for better monitoring and control.

The receive agent 121 communicates with the central server 103 and receives the updated package file. After receiving the package file, it confirms to the central server 103 about the success of its receipt. These package files sent from central server 103 would generally be compressed and would be decompressed via uncompress 122 at the local server's end for update or further distribution to client devices 101 as the case may be. Download store 123 provides a data area as a means for electronic storage of the update package files sent by central server 103 for updating local server 102 and/or various client operating systems or applications

The local server update agent communicating with the local server download agent features an updater 124 which reviews the update package file and compares with the local server Core/firmware. After identifying the differences, the updater 124 accordingly makes changes in respective memory locations so as to update the server core/firmware. It can also be used to update any application running on the local server 102. After a successful update, initializer 125 sets the necessary parameters and initializes the core/firmware which might involve restarting of the server core or applications as the case may be. The communicator 126, provides for communication between the local download and local server update agent. It could also potentially communicate to log agent 109 or server core as required.

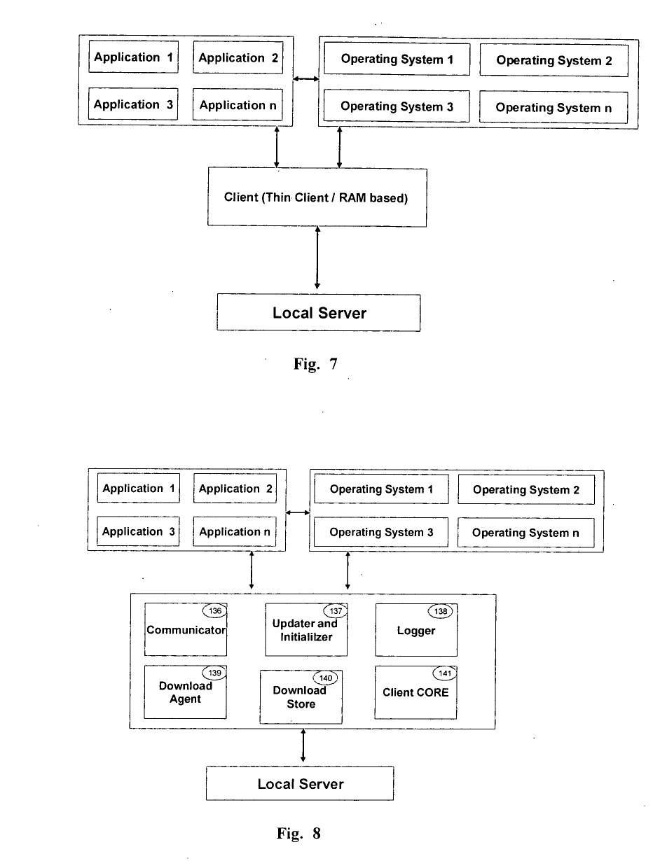

Shown in FIG. 7, the local client device could have a thin client residing in the device or a RAM based client which is installed in RAM and destroyed once the updated is performed successfully. The client (either thin client or RAM based update) would have components to successfully update the client device. These components include communicator 136, download agent 139, updater and initializer 137, download store 140, logger 138, and client core 141.

Communicator 136 is used to communicate with both the local server 102 and client device 101 for receiving and updating the package files. It also communicates to the local device or local server about the status of various updates. The updater 137 analyses the update package file and compares it with the relevant client application/firmware. After identifying the differences, it accordingly makes changes in respective memory locations so as to update the client application/firmware.

After a successful update, initializer 137 sets the necessary parameters and initializes the application/firmware which might involve restarting of the client device 101 or applications thereon as the case may be. Logger 138 is used to log various activities related to Local client download, updates, and other functions.

Download agent 139 is responsible for downloading the package files and other instructions from local server 102. It downloads relevant package files and stores them under download store 140 which is a data area providing electronic means to store the package files sent by local server 102 for updating client Operating Systems or applications. The client CORE 141 contains the core application of the client and is itself updateable with the update package files sent by the local server 102.

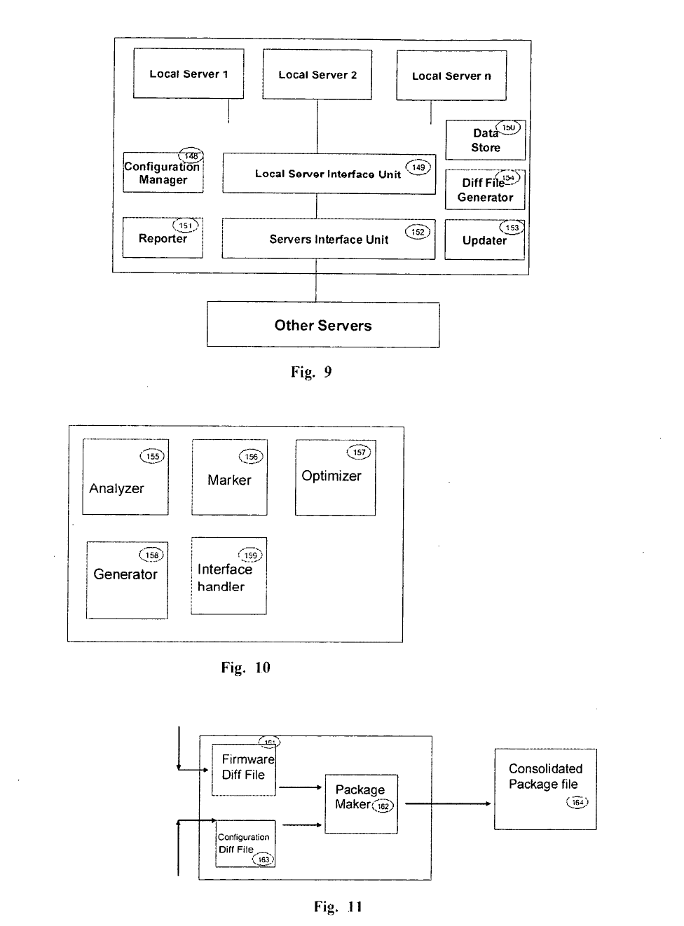

As depicted in FIG. 9, configuration manager 148 provides an interface to central server 103 users for configuring central server 103 or relevant local server 102. A configuration of central server is generally done by super users of the server. Local server interface unit 149 is used to communicate to one or more local servers 102. Data store 150 is provided to store the update package files which would be communicated to the local server 102 at appropriate time i.e., when the update is initiated either by local server 102 or by central server user. It is used to store the archival of the logs of local servers, logs of central servers, previous update package files and update packages files yet to be updated to local clients.

Reporter 151 is used for generating various reports from logs as well as update transactions to central server users. Reporter 151 may be integrated to any web based or non-web-based reporting interface for additional reporting. Servers interface units 152 provide means to communicate to other servers in the proximity of the device location. This is mainly used if the central server 103 requires update package files from one or more other servers.

The updater 153 component is used to update itself with the newer versions of the server. Diff file generator 154 is an engine employed to create diff files which are sent to local server 102 for updating either local server 102 and/or various client devices.

Depicted in FIG. 10, analyzer 155, performs the analysis of the previous and new versions and identifies the changes to the previous version which results in a new version. Marker 156 identifies the changes and makes note of them in a temporary memory location, so that the generator 158 could create a diff file based on the changes identified and marked. Optimizer 157 analyses the marked data and rationalizes it for better memory management which would result in optimal pre-compressed size of the package file. The diff file created by generator 158 is based on analyzer 155, marker 156 and optimizer 157, and is compressed during creation of the package file, whereafter interface handler 159 provides means for communication between diff file generator 158 and Central Server 103 and components.

Shown in FIG. 11 is the firmware diff file 161 which is the diff file generated between previous and latest version of firmware. Package maker 162 is employed to consider the diff files of firmware and/or software and configuration parameters of the device to operate and create a combined and compressed packaged file. Configuration diff file 163 is the diff file generated between relevant previous and latest version of configuration files, indicating the individual configuration of the device required for its operation. For example, on a cellular phone that is internet browsing enabled it may have a specific IP address configuration which needs to be addressed in the update so it will still operate subsequent to the update. Consolidate diff file 164 is the output of the package maker and is a consolidated and compressed diff file. The method and apparatus for upgrading of firmware, and/or operating systems, and/or software of a plurality of components and electronic devices shown in the drawings and described in detail herein, disclose steps in a process, arrangements of elements of particular construction, and configuration for illustrating preferred embodiments of structure and method of operation of the present invention. It is to be understood, however, that elements of different construction and configuration and different steps and process procedures and other arrangements thereof, other than those illustrated and described, may be employed for providing such updates of interrelated electronic components with the spirit of this invention.

As such, while the present invention has been described herein with reference to particular embodiments thereof, a latitude of modifications, various changes and substitutions are intended in the foregoing disclosure, and it will be appreciated that in some instance some features of the invention could be employed without a corresponding use of other features without departing from the scope of the invention as set forth in the following claims. All such changes, alternations and modifications as would occur to those skilled in the art are considered to be within the scope of this invention as broadly defined in the appended claims.

What is claimed is:

1. A computer implemented method for updating firmware and: software for electronic devices comprising the steps of:
communicating an update package having one or a combination of software updates and firmware updates, for said electronic device, from a central server, to at least one local server;
communicating update instructions for said electronic device from a central server to said local server;
storing said update package and said update instructions on said local server;
providing means for communication of said electronic device with said local server;
providing means to determine said electronic device is in communication with said local server;
providing means to execute said update instructions to install said one or a combination of software updates and firmware updates, upon said electronic device, when said electronic device is determined to be in communication with said local server; and
executing said update instructions.

2. The method for updating firmware and software of claim 1 comprising the additional steps of:
arranging with a manufacturer of, or service provider for, said electronic device, to communicate said update package to said electronic device, with or without a request for said update package from said electronic device or a user of said electronic device.

3. The method for updating firmware and software of claim 1 wherein said providing means for communication of said electronic device with said local server comprises:
providing a plurality of local means for communication each adapted to communicate with said electronic devices;
updating said electronic device with said one or a combination of software updates and firmware updates resident on said local server, when said electronic device communicates with said local through a said local means for communication; and
whereby said electronic device can be updated by either manufacturers or users of said electronic device when said electronic device communicates with said local server through said local means for communication, thereby alleviating a need to transport said electronic device to a manufacturer or service provider for said update.

4. The method for updating firmware and software of claim 2 wherein said providing means for communication of said electronic device with said local server comprises:
providing a plurality of local means for communication each adapted to communicate with said electronic devices;
updating said electronic device with said one or a combination of software updates and firmware updates resident on said local server, when said electronic device communicates with said local through a said local means for communication, and
whereby said electronic device can be updated by either manufacturers or users of said electronic device when said electronic device communicates with said local server through said local means for communication, thereby alleviating a need to transport said electronic device to a manufacturer or service provider for said update.

5. The method for updating firmware and software of claim 3 wherein said providing a plurality of local means for communication comprises:
locating wireless means for communication adapted to communicate with said electronic device when brought within a proximity thereof.

6. The method for updating firmware and software of claim 4 wherein said providing a plurality of local means for communication comprises:
locating wireless means for communication adapted to communicate with said electronic device when brought within a proximity thereof.

7. The method for updating firmware and software of claim 4 comprising the additional steps of:
providing said manufacturer or service provider with update software for inclusion in said electronic device; and
adapting said update software to seek and establish communication with said local means for communication.

8. The method for updating firmware and software of claim 6 comprising the additional steps of:
providing said manufacturer or service provider with update software for inclusion in said electronic device; and
adapting said update software to seek and establish communication with said local means for communication.

9. The method for updating firmware and software of claim 1 comprising the additional steps of:
communicating a plurality of said update packages for said electronic device for storage on said local server;
including means to query said electronic device as to a current state of its configuration, software and firmware in said update instructions for said electronic device communicated to, and stored on, said local server;
querying said electronic device as to said current state of its software and firmware;
receiving a response from said querying; and communicating a one of said plurality of update packages resident on said local server, based on said response.

10. The method for updating firmware and software of claim 2 comprising the additional steps of:
communicating a plurality of said update packages for said electronic device for storage on said local server;
including means to query said electronic device as to a current state of its software and firmware in said update instructions for said electronic device communicated to and stored on said local server;
querying said electronic device as to said current state of its software and firmware;
receiving a response from said querying; and communicating a one of said plurality of update packages resident on said local server based on said response.

11. The method for updating firmware and software of claim 3 comprising the additional steps of:
communicating a plurality of said update packages for said electronic device for storage on said local server;
including means to query said electronic device as to a current state of its software and firmware in said update instructions for said electronic device communicated to and stored on said local server;
querying said electronic device as to said current state of its software and firmware;
receiving a response from said querying; and
communicating a one of said plurality of update packages resident on said local server based on said response.

12. The method for updating firmware and software of claim 4 comprising the additional steps of:
communicating a plurality of said update packages for said electronic device for storage on said local server;
including means to query said electronic device as to a current state of its software and firmware in said update instructions for said electronic device communicated to and stored on said local server;
querying said electronic device as to said current state of its software and firmware;
receiving a response from said querying; and
communicating a one of said plurality of update packages resident on said local server based on said response.

13. The method for updating firmware and software of claim 5 comprising the additional steps of:
communicating a plurality of said update packages for said electronic device for storage on said local server;
including means to query said electronic device as to a current state of its software and firmware in said update instructions for said electronic device communicated to and stored on said local server;
querying said electronic device as to said current state of its software and firmware;
receiving a response from said querying; and communicating a one of said plurality of update packages resident on said local server based on said response.

14. The method for updating firmware and software of claim 6 comprising the additional steps of:
communicating a plurality of said update packages for said electronic device for storage on said local server;
including means to query said electronic device as to a current state of its software and firmware in said update instructions for said electronic device communicated to and stored on said local server;
querying said electronic device as to said current state of its software and firmware;
receiving a response from said querying; and communicating a one of said plurality of update packages resident on said local server based on said response.

15. The method for updating firmware and software of claim 7 comprising the additional steps of:
communicating a plurality of said update packages for said electronic device for storage on said local server;
including means to query said electronic device as to a current state of its software and firmware in said update instructions for said electronic device communicated to and stored on said local server;
querying said electronic device as to said current state of its software and firmware;
receiving a response from said querying; and
communicating a one of said plurality of update packages resident on said local server based on aid response.

16. The method for updating firmware and software of claim 9 comprising the additional steps of:
ascertaining potential conflicts between said firmware, said software, and hardware, resident on said electronic device;
ascertaining a preferred update package from said plurality of update packages resident on said local server or said central server which will substantially eliminate or reduce said potential conflicts if installed; and
communicating said preferred update package to said electronic device.

17. The method for updating firmware and software of claim 10 comprising the additional steps of:
ascertaining potential conflicts between said firmware, said software, and hardware, resident on said electronic device;
ascertaining a preferred update package from said plurality of update packages resident on said local server or said central server which will substantially eliminate or reduce said potential conflicts if installed; and
communicating said preferred update package to said electronic device.

18. The method for updating firmware and software of claim 11 comprising the additional steps of:
ascertaining potential conflicts between said firmware, said software, and hardware, resident on said electronic device;
ascertaining a preferred update package from said plurality of update packages resident on said local server or said central server which will substantially eliminate or reduce said potential conflicts if installed; and
communicating said preferred update package to said electronic device.

19. The method for updating firmware and software of claim 12 comprising the additional steps of:
ascertaining potential conflicts between said firmware, said software, and hardware, resident on said electronic device;
ascertaining a preferred update package from said plurality of update packages resident on said local server or said central server which will substantially eliminate or reduce said potential conflicts if installed; and
communicating said preferred update package to said electronic device.

20. The method for updating firmware and software of claim 13 comprising the additional steps of:
ascertaining potential conflicts between said firmware, said software, and hardware, resident on said electronic device;
ascertaining a preferred update package from said plurality of update packages resident on said local server or said central server which will substantially eliminate or reduce said potential conflicts if installed; and
communicating said preferred update package to said electronic device.

21. The method for updating firmware and software of claim 14 comprising the additional steps of:
ascertaining potential conflicts between said firmware, said software, and hardware, resident on said electronic device;
ascertaining a preferred update package from said plurality of update packages resident on said local server or said central server which will substantially eliminate or reduce said potential conflicts if installed; and
communicating said preferred update package to said electronic device.

22. The method for updating firmware and software of claim 15 comprising the additional steps of:
ascertaining potential conflicts between said firmware, said software, and hardware, resident on said electronic device;
ascertaining a preferred update package from said plurality of update packages resident on said local server or said central server which will substantially eliminate or reduce said potential conflicts if installed; and
communicating said preferred update package to said electronic device.

23. The method for updating firmware and software of claim 20 comprising the additional steps of:
adapting said local means for communication to communicate with automobiles; and
locating said wireless means for communication at points along highways wear said automobiles conventionally stop for a duration of time, whereby one or a plurality of said electronic devices, located on said automobile can have one or both of their software and hardware updated.

24. The method of updating firmware and software of claim 1 comprising the additional step of:
securing a subscription from a manufacturer or service provider of said electronic device to communicate said update package;
receiving said update package from said manufacturer or service provider;
employing means to identify designated electronic devices requiring said update package;
from said electronic devices determined in contact with said local server, determining if said electronic device is a designated electronic device; and
executing said update instructions only with communicating designated electronic devices.

25. The method of updating firmware and software of claim 24 comprising the additional step of:
providing a plurality of local means for communication each adapted to communicate with any said designated electronic device; and
providing geographic locations of said local means for communication to said manufacturer or service provider for communication to users of said designated electronic devices, whereby said designated electronic devices can be taken to any of said local means for communication to receive said update package.

26. The method of updating firmware and software of claim 24 comprising the additional step of:
providing said means to execute said update instructions to said manufacturer or service provider within update agent software for inclusion in said electronic device prior to said user taking possession of said electronic device; and
said update agent executing said update instructions.

27. The method of updating firmware and software of claim 26 comprising the additional step of:
including user authorization for execution of said update instructions in said update agent;
allowing said user to approve or deny execution of said update instructions; and
executing said update instructions only when said user approves.

28. The method of updating firmware and software of claim 26 comprising the additional step of:
including user authorization for execution of said update instructions in said update agent;
allowing said user to approve or deny execution of said update instructions; and
allowing said user to initiate said contact with said local server.

29. The method of updating firmware and software of claim 24 comprising the additional step of:
providing said means to execute said update instructions within update agent software stored on said local servers; and
said update agent executing said update instructions upon communicating designated electronic devices.

30. The method of updating firmware and software of claim 24 comprising the additional step of:
downloading said update agent to said designated electronic device upon communication with said server.

31. The method of updating firmware and software of claim 26 comprising the additional step of:
including means to query said electronic device as to a current state of its software and firmware in said update agent;
querying said designated electronic device as to said current state of its software and firmware;
receiving a response from said querying;
providing said update agent with software routines to determine and avoid conflicts between software and hardware identified in said response;
providing said update agent with software routines to create a custom said update package avoiding said conflicts, based on said response to the individual state of the designated electronic device responding; and
said update agent executing said custom update package.

32. The method for updating firmware and software of claim 9 wherein said communicating a plurality of update packages to said local server includes:
communicating to said local server for storage thereon, a plurality of individual software and firmware components for inclusion into said preferred update package, to said local server;
communicating to said local server for storage thereon, a listing of respective preferred individual components of said software and firmware components, for inclusion in said preferred update package, depending on said response to said query as to said current state of said software and firmware on said device;
employing software resident on said local server, to generate said preferred update package, including said preferred individual components ascertained as a result of said response to said query; and
communicating to said device, said preferred update package whereby a custom said preferred update package for each device, can be derived and thereafter communicated to said device based on the current state of said hardware and firmware and software resident thereon prior to said query of said device.

33. The method for updating firmware and software of claim 16 comprising the additional steps of:
communicating to said local server for storage thereon, a plurality of individual software and firmware components for inclusion into said preferred update package, to said local server;
communicating to said local server for storage thereon, a listing of respective preferred individual components of said software and firmware components, for inclusion in said preferred update package, depending on said response to said query as to said current state of said software and firmware on said device;
employing software resident on said local server, to generate said preferred update package, including said preferred individual components ascertained as a result of said response to said query; and
communicating to said device, said preferred update package whereby a custom said preferred update package for each device, can be derived and thereafter communicated to said device based on the current state of said hardware and firmware and software resident thereon prior to said query of said device.

34. The method for updating firmware and software of claim 1 comprising the additional steps of:
providing means for said central server to query said Local server to monitor its status, and to ascertain requirements for said updates from client devices communicating with said local server.

35. The method for updating firmware and software of claim 4 wherein said manufacturers are automobile manufactures and said electronic devices are operationally engaged to automobiles, comprising the additional steps of:
locating said local means of communication with said electronic devices proximate to automobile toll booths.
